(19) United States
(12) Patent Application Publication
(10) Pub. No.: US 2006/0038844 A1
(43) Pub. Date: Feb. 23, 2006

(54) Image forming device, image forming method, printing instruction device, printing instruction method and image processing system

(75) Inventors: Masakatsu Kiwada, Sagamihara-shi (JP); Kazuto Yamamoto, Kunitachi-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 10/991,991

(22) Filed: Nov. 19, 2004

(30) Foreign Application Priority Data
Aug. 17, 2004 (JP) 2004-237115

(51) Int. Cl. B41J 29/38

(52) U.S. Cl. 347/16

(57) ABSTRACT

An MFP provided as an image forming device reads the paper management information including the information of a department which is authorized to use paper, which is stored on an IC tag provided on the paper, and the paper management information thus obtained is stored in the storage unit. Also, upon receiving the transmission request for the paper management information via the network, the MFP transmits the paper management information stored in the storage unit back to the request source.

This application is based on Japanese Patent Application No. 2004-237115 filed on Aug. 17, 2004, the contents of which are hereby incorporated by reference.

### BACKGROUND OF THE INVENTION

1. Field of the Invention

The invention relates to an image forming device, an image forming method, a printing instruction device, a printing instruction method, and an image processing system. The invention relates to, in particular, an image forming device, an image forming method, a printing instruction device, a printing instruction method, and an image processing system for managing the use of a recording medium such as paper.

2. Description of the Related Art

Various organizations including business corporations are now eager to control the amount of paper used on image forming devices from the standpoint of effective management of resources and global environmental protection. It is customary in those cases to control the number of sheets of paper to be used on image forming devices of each department of a company.

A technology has been known intended for controlling the number of sheets of paper to be used by causing the user to insert a card issued for the user's department, which limits copying actions only up to a specified number (Unexamined Publication No. JP-A-6-202.397).

However, it is often a case lately that an image forming device connected to a network is shared by users of a plurality of departments through such a network. In case of such an image forming device that is used as a network printer, multiple printing requests may be received simultaneously from users of multiple departments, so that it is difficult to control paper consumption using such cards issued for those departments.

On the other hand, there is a control method in which paper purchased by each department is set in a predetermined paper feeding tray and each user is supposed to use paper feeding tray assigned to his/her department. However, it can cause a problem such that the paper is loaded into a wrong paper feeding tray that belongs to a wrong department or the paper originally loaded in a correct paper feeding tray is mistakenly transferred to another tray for some reasons, which makes the paper consumption control inaccurate.

### SUMMARY OF THE INVENTION

It is an object of the present invention to provide an image processing device, an image processing method, a printing instruction device, a printing instruction method, and an image processing system, which are improved for solving the abovementioned problems.

It is a more specific object of the present invention to provide an image processing device, an image processing method, a printing instruction device, a printing instruction method, and an image processing system, which enable to control paper to be used on the image forming device more accurately for each department.

According to an aspect of the invention, there is provided an image forming device, comprising: a reading unit for reading recording medium management information including the information of a department authorized to use a recording medium, which is stored in an IC tag provided on said recording medium; and a storage unit for storing the recording medium management information read by said reading unit.

According to this invention, regardless of which recording medium storage part of the image forming device a recording medium is set, it is possible to identify in advance the department to which use is authorized for every recording medium set in the image forming device. Consequently, the recording medium to be used on the image forming device can be controlled accurately for each department, thus contributing to effective management of resources and global environmental protection.

According to another aspect of the invention, there is provided a printing instruction device, comprising: a receiving unit for receiving recording medium management information including the information of a department authorized to use a recording medium, which is stored in an IC tag provided on said recording medium loaded in an image forming device, from said image forming device via a network; and a display unit for displaying the image forming device, which is equipped with a recording medium authorized to be used by the department to which a user issuing a printing instruction belongs, as a selectable image forming device based on said recording medium management information.

According to still another aspect of the invention, there is provided an image processing system, comprising: a printing instruction device; and an image forming device communicable with said printing instruction device via a network, said image forming device including: a requesting unit for requesting recording medium management information including the information of a department authorized to use a recording medium, which is stored in an IC tag provided on said recording medium loaded in an image forming device, to said image forming device; a receiving unit for receiving said recording medium management information from said image forming device via the network; and a display unit for displaying an image forming device, which is equipped with a recording medium authorized to be used by the department to which a user issuing a printing instruction belongs, as a selectable image forming device based on said recording medium management information, said image forming device including: a reading unit for reading said recording medium management information stored in an IC tag provided on the recording medium; a storage unit for storing the recording medium management information read by said reading unit; a receiving unit for receiving a request for said recording medium management information via the network; and a return transmission unit for returning said recording medium management information stored in said storage unit when said request is received.

According to a further aspect of the invention, there is provided an image forming method comprising the steps of:
1) reading recording medium management information including the information of a department authorized to use a recording medium, which is stored in an IC tag provided on said recording medium; and 2) storing the recording medium management information read in the step 1).

According to a still further aspect of the invention, there is provided a printing instruction method comprising the steps of: 1) receiving recording medium management information including the information of a department authorized to use a recording medium, which is stored in an IC tag provided on said recording medium loaded in an image forming device, from said image forming device via a network; and 2) displaying the image forming device, which is equipped with the recording medium authorized to be used by the department to which a user issuing a printing instruction belongs, as a selectable image forming device based on said recording medium management information.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of an image processing system according to the first embodiment of the present invention.

FIG. 2 is a general front view showing the constitution of the MFP shown in FIG. 1.

FIG. 3 is a block diagram showing the constitution of the MFP shown in FIG. 1.

FIG. 4 is a block diagram showing the constitution of the PC shown in FIG. 1.

FIG. 5 is a schematic diagram showing a constitution of IC-tagged paper.

FIG. 6 is a diagram for describing the contents of the electronic data stored in the IC tag shown in FIG. 5.

FIG. 7 is a flowchart showing the sequence of a printing instruction process on the PC.

FIG. 8 is a diagram showing an example of the image forming device selection screen.

FIG. 9 is a diagram showing an example of the paper feeding tray selection screen.

FIG. 10 is a diagram showing another example of the paper feeding tray selection screen shown in FIG. 9.

FIG. 11 is an example of the contents of departmental information received from MFP 10.

FIG. 12 is an example of the contents of departmental information received from MFP 11.

FIG. 13 is an example of the contents of departmental information received from MFP 12.

FIG. 14 is an example of the contents of departmental information received from MFP 13.

FIG. 15 is a flowchart showing the storage process sequence for the paper management information on the MFP.

FIG. 16 is a flowchart showing the printing process sequence on the MFP.

FIG. 17 is a general perspective view of a bundle of paper including IC-tagged paper related to the second embodiment of the invention.

FIG. 18 is a diagram for describing the contents of the electronic data stored in the IC tag shown in FIG. 17.

### DETAILED DESCRIPTION OF THE INVENTION

The embodiments of this invention will be described below with reference to the accompanying drawings.

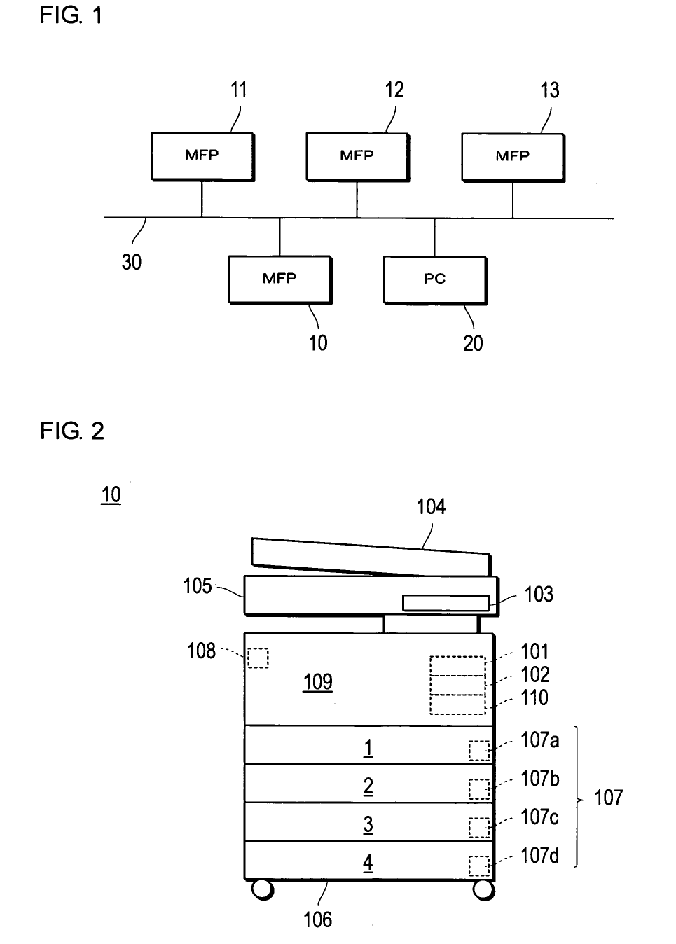

FIG. 1 is a block diagram showing the overall constitution of an image processing system according to the first embodiment of the present invention. The image processing system is equipped with MFPs (Multi-Function Peripherals) 10 through 13 being used as image forming devices and a PC (personal computer) 20 being used as a printing instruction device, all of which are interconnected via a network 30 so that they can communicate with each other. The types and the number of equipment to be connected to the network 30 are not limited to those shown in FIG. 1. Either of the MFPs 10 through 13 and the PC 20 do not necessarily have to be connected via the network 30 but can be connected directly with each other (local connection).

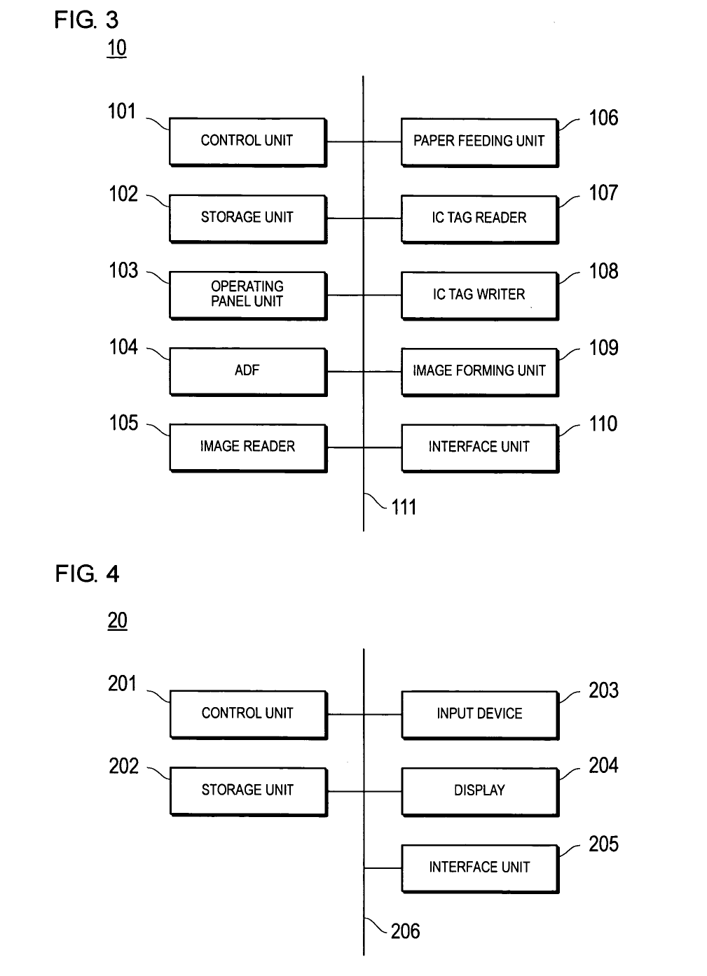

FIG. 2 is a general front view showing the constitution of the MFP shown in FIG. 1, and FIG. 3 is a block diagram showing the constitution of the MFP shown in FIG. 1.

MFP 10 is equipped with a control unit 101, a storage unit 102, an operating panel unit 103, an ADF (Auto Document Feeder) 104, an image reader 105, a paper feeding unit 106, an IC tag reader 107, an IC tag writer 108, an image forming unit 109, and an interface unit 110, all of which are interconnected via a bus 111 for exchanging signals with each other. The MFPs 11 through 13 are constituted identical to the MFP 10.

The control unit 101 is a CPU, and controls various parts indicated above and executes various arithmetic processes according to a program. The storage unit 102 consists of a ROM for storing various programs and data, a RAM for temporarily storing programs and data as a working area, a hard disk for storing various programs and data including an operating system, etc.

The operating panel unit 103 is equipped with a touch panel, a ten-key pad, a start button, a stop button and others to be used for displaying various kinds of information and entering various instructions.

The ADF 104 transports a single or multiple sheets of paper one sheet at a time to a specified reading position of the image reader 105, and discharges the document sequentially after reading it.

The image reader 105 irradiates a document set on a specified scanning location or transported to the specified reading position by the ADF 104 with a light source such as a fluorescent lamp and the like, converts reflected lights from the document surface into electrical signals with the help of light sensitive devices such as CCD, and generates image data from the electrical signals.

The paper feeding unit 106 can contain paper as recording media to be used in printing and send the contained paper one sheet at a time to the image forming unit 109. The paper feeding unit 106 has, for example, four paper feeding trays 1 through 4.

The IC tag readers 107a through 107d are provided in the vicinity of the paper feeding trays 1 through 4 respectively. The IC tag reader 107 (a collective name for 107a through 107d) reads electronic data stored in the IC tag of the paper provided with an IC tag (“IC-tagged paper”) to be described later. The IC tag reader 107 can read the entire electronic data stored in the IC tag reader or read the data by each specified unit depending on the instruction of the control unit 101. As the communication system between the IC tag reader 107 and the IC tag, those of the international standards such as ISO 14443 and ISO 15693 can be applied using frequency bands such as 135 kHz, 13.56 MHz, and 2.45 GHz. The normally used frequency band is 13.56 MHz and the communication range is approximately 30 cm when said frequency band is used. However, the communication systems that can be applied are not limited to those mentioned above, and other known communication systems or proprietary communication systems may be used.

The IC tag reader 107 can detect whether an IC tag is provided or not on the paper contained in the paper feeding unit 106. For example, the presence of an IC tag in the paper can be detected by transmitting a radio wave from the IC tag reader 107 and checking if the radio wave is transmitted back from the IC tag to the IC tag reader 107. The method of detecting the presence of an IC tag in the paper is not limited to the method described above, and other detection methods can be used as well. The presence of an IC tag in the paper can be detected immediately before reading the electronic data in the IC tag, when setting the paper to the paper feeding unit 106, when starting up the MFP 100, or at a specified interval. However, the procedure conducted for IC-tagged paper will be described below.

The IC tag writer 108 is used to write electronic data on the IC tag on the IC-tagged paper to be described later. The IC tag writer 108 can be an identical unit as the IC tag reader 107, and the communication system between the IC tag writer 108 and the IC tag can be the same as that of the IC tag reader 107.

The image forming unit 109 prints various data on paper using a known imaging process such as the electronic photographing process including such processes as electrical charging, exposure, developing, transferring and fixing.

The interface unit 110 is an interface for communicating with external equipment, and network interfaces such as Ethernet®, Token Ring, and FDDI standards, serial interfaces such as USB and IEEE 1394, parallel interfaces such as SCSI and IEEE 1284, wireless communication interfaces such as Bluetooth®, IEEE 802.11, HomeRF®, and IrDA®, as well as telephone circuit interfaces for connection to telephone circuits can be used.

The MFPs 10 through 13 have the printing function for printing according to an instruction form an external device such as the PC 20 or a cellular telephone, and the copying function for copying documents.

FIG. 4 is a block diagram showing the constitution of the PC shown in FIG. 1. The PC 20 is equipped with a control unit 201, a storage unit 202, an input device 203, a display 204, and an interface unit 205, all of which are interconnected via a bus 206 for exchanging signals with each other. Of various units of the PC 20, those units that have identical functions as those of the MFP 10 will not be described here in order to avoid duplications.

The storage unit 202 has an application program for generating document files and a printer driver for converting the document files into print data described in a language understood by the MFPs 10 through 13 installed.

The display 204 is, for example, a liquid crystal display for displaying various kinds of information. Input device 203 consists of a pointing device such as a mouse, a keyboard, and others, and is used for making various kinds of inputs.

The MFPs 10 through 13 as well as PC 20 can each have components other than those described above or lack a portion of those components described above.

The network 30 can be a LAN connecting computers and network equipment according to standards such as Ethernet®, Token Ring, and FDDI, or a WAN that consists of several LANs connected by a dedicated line.

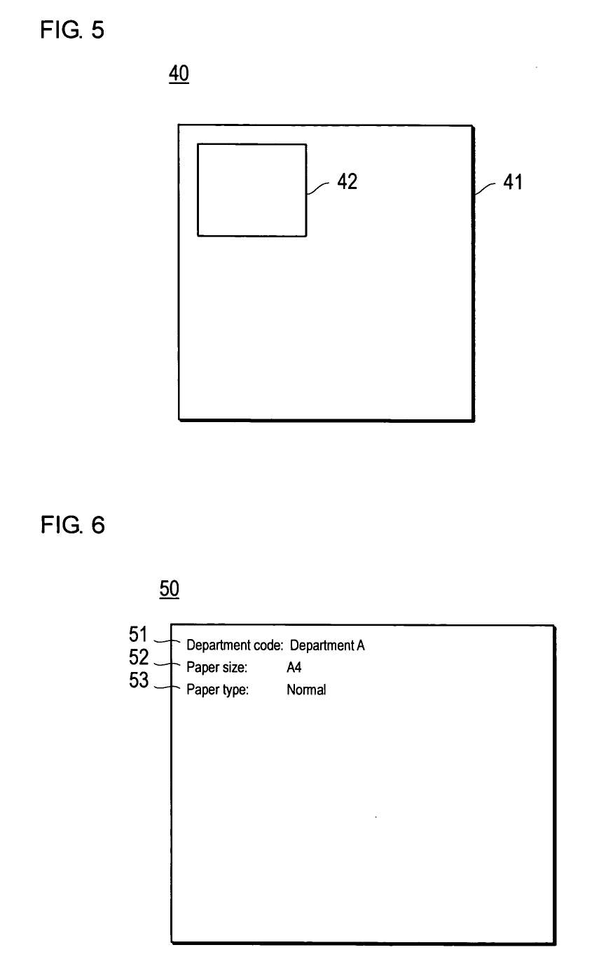

Next, the IC-tagged paper according to the present embodiment will be described. FIG. 5 is a schematic diagram showing a constitution of paper provided with an IC tag (“IC-tagged paper”) 40. The IC-tagged paper 40 is provided with an IC tag 42 at least in a portion of paper 41. The IC tag 42 can be glued on to the paper 41 or embedded in the paper 41. There can be a single IC tag or a multiplicity of IC tags 42 on a single sheet of paper 41.

The IC tag 42 is a non-contacting type electronic tag using wireless communication and contains a memory part consisting of an IC chip and an antenna part consisting of a coil (neither of them shown) in the inside. The IC tag 42 receives radio waves emitted from the IC tag reader 107 or the IC tag writer 108 to conduct wireless communications with the IC tag reader 107 or the IC tag writer 108 by means of electromagnetic induction coupling and allows reading and writing of electronic data.

FIG. 6 is a diagram for describing the contents of the electronic data stored in the IC tag 42 shown in FIG. 5. The memory part of the IC tag 42 stores paper management information 50. The paper management information 50 includes department information 51 indicating a department which is authorized to use the paper, paper size information 52 showing a paper size, and paper type information 53 for showing the type of paper. The term “department” used here means any unit of an organization such as a corporation, which can be a department or a section. Incidentally, the contents of the information stored in the IC tag 42 as electronic data and the format of the electronic data are not limited to those examples shown in FIG. 6.

The operation of the image processing system in this embodiment will be described in the following.

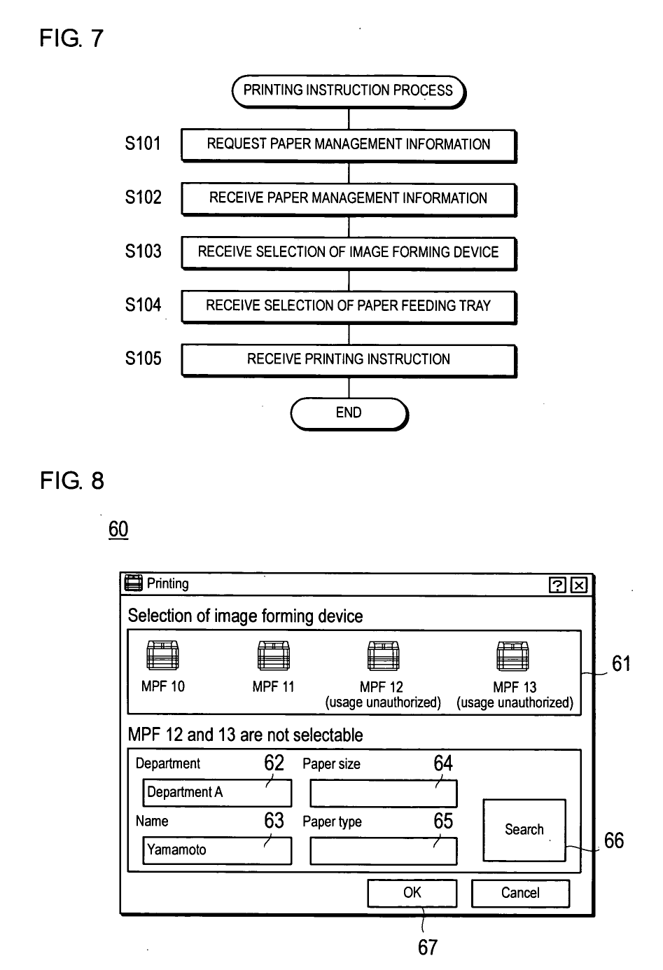

FIG. 7 is a flowchart showing the sequence of a printing instruction process on the PC 20. The algorithm shown in the flowchart of FIG. 7 is stored as a program in the storage unit 202 of the PC 20, which is executed by the control unit 201.

The PC 20 requests the paper management information from the MFPs 10 through 13 on the network 30 (S101). In other words, the transmission request for the paper management information is transmitted to each one of the MFPs 10 through 13. More specifically, the image forming device selection screen will be displayed on the display 204 when the printer driver is activated, and the paper management information is requested through this image forming device selection screen.

FIG. 8 is a diagram showing an example of the image forming device selection screen. The image forming device selection screen 60 has input boxes 62 through 65 for entering user's department name, user's name, paper size and paper type. When a search button 66 is pressed after entering the user's department name and the user's name, a transmission request including the user's department name and the user's name for the paper management information is transmitted to each MFP 10 through 13.

The PC 20 then receives the paper management information 50 from each MFP 10 through 13 (S102). The paper management information 50 includes information about the remaining amount of paper in addition to the aforementioned department information 51, paper size information 52, and paper type information 53. If it fails to prove that the user concerning the transmission request belongs to the department indicated in the transmission request, a specified error message will be received. In such a case, the transmission request for the paper management information must be repeated.

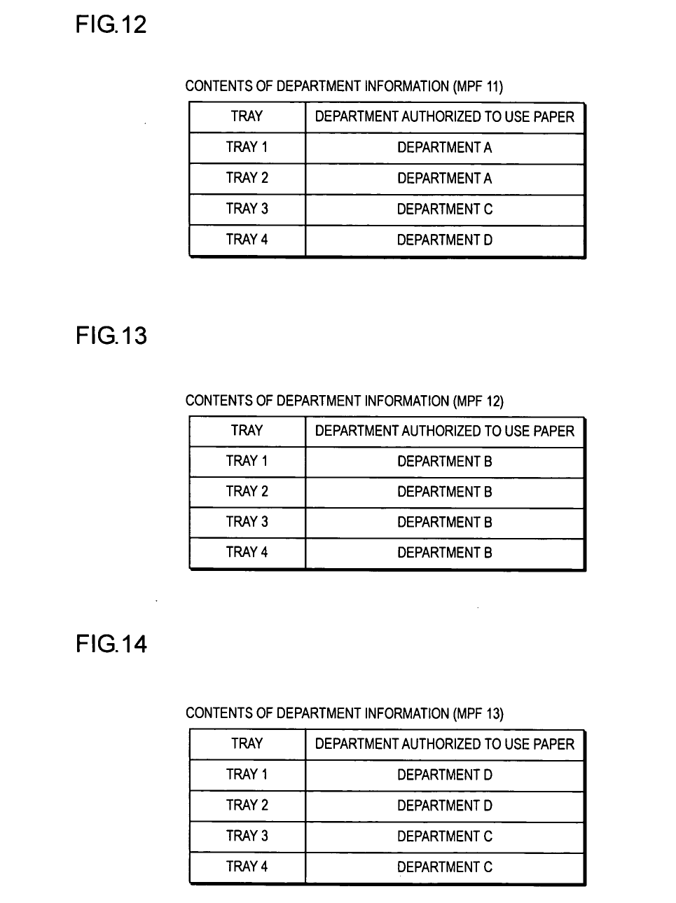

FIG. 11 through FIG. 14 show examples of contents of the department information contained in the paper management information 50 received from MFPs 10 through 13 respectively. As shown in those drawings, the paper feeding trays assigned to the department A are paper feeding trays 1 through 3 of the MFP 10 and paper feeding trays 1 and 2 of the MFP 11. The paper feeding trays assigned to the department B are paper feeding tray 4 of the MFP 10 and paper feeding trays 1 through 4 of the MFP 12. The paper feeding trays assigned to the department C are paper feeding tray 3 of the MFP 11 and paper feeding trays 3 and 4 of the MFP 13. The paper feeding trays assigned to the department Dare paper feeding tray 4 of the MFP 11 and paper feeding trays 1 and 2 of the MFP 13.

A search is made here for MFPs which are provided with paper that can be used by the user's department based on the paper management information received from each MFP 10 through 13. As a result of the search, the MFPs provided with the paper that can be used by the user's department are displayed in a result display area 61 for the user's selection. On the other hand, any MFP that exists on the network 30 but is prohibited from being used is either grayed out or not shown, preventing the user from selecting it. Moreover, it can be constituted in such a way that a search is made for MFPs that satisfy all the conditions when the search button 66 is pressed after the paper size and paper type entries are made.

Next, the PC 20 receives the user's selection of the image forming device on the image forming device selection screen 60 shown in FIG. 8 (S103). When an OK button 67 is pressed after the MFP 11 is selected in the result display area 61 of the image forming device selection screen 60, the display switches to the paper feeding tray selection screen.

The PC 20 then receives the user's selection of a paper feeding tray (S104).

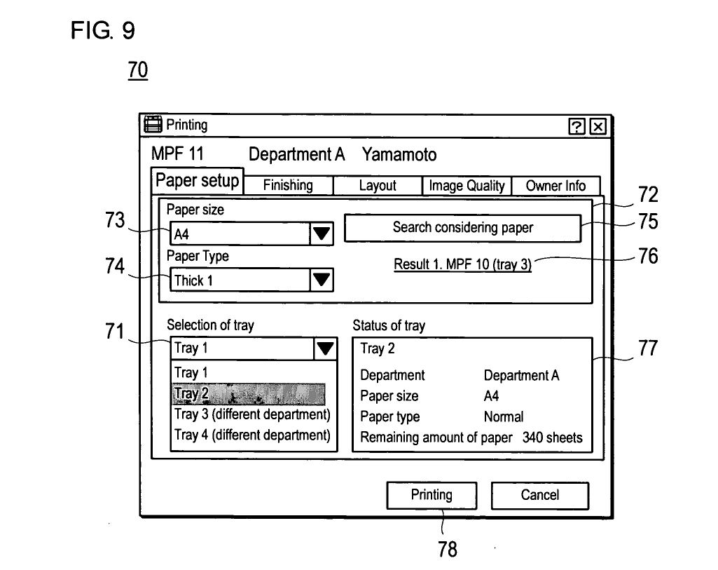

FIG. 9 is a diagram showing an example of the paper feeding tray selection screen. The paper feeding tray selection screen 70 has a paper feeding tray selection section 71 for receiving the user's selection of a paper feeding tray of the selected MFP and a search section 72 for searching an image forming device which is provided with the desired paper. The status of the paper feeding tray selected at the paper feeding tray selection section 71 is displayed in a tray status display area 77. The tray status display area 77 displays the department which is authorized to use the particular paper, the paper size, the paper type, and the remaining amount of paper.

If there is no paper in either of the paper feeding trays provided on the selected MFP, the search section 72 can be used for searching. When a search button 75 is pressed after the required input information is entered in input boxes 73 and 74 for entering the paper size and the paper type of the search section 72, a search is made for MFPs which match the required status considering the paper. The result of the search is displayed in a result display area 76.

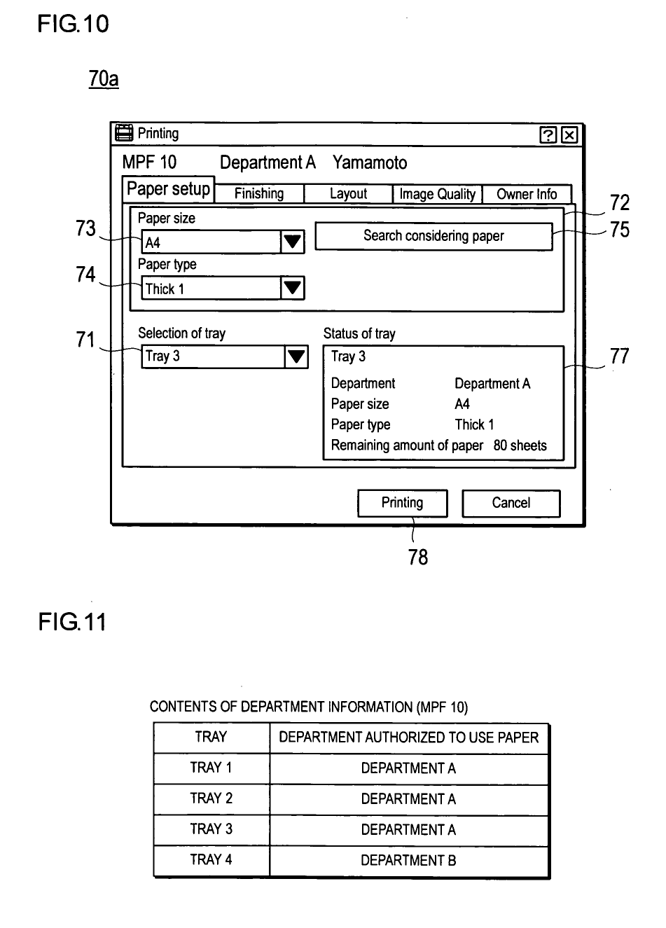

FIG. 10 is a diagram showing another example of the paper feeding tray selection screen shown in FIG. 9. FIG. 10 shows a screen switched when the MFP 10 is selected in the result display area 76 of the paper feeding tray selection screen 70 shown in FIG. 9. The selection of a paper feeding tray equipped with the paper desired by the user is received in the paper feeding tray selection section 71 of the paper feeding tray selection screen 70a.

The printing instruction by the user is received in the step S105. For example, a printing instruction is received as a print button 78 of the paper feeding tray selection screen 70a is pressed by the user. At this point, the print request that contains the print data corresponding to the printing instruction and the printing setup information including the instruction information for the paper feeding tray to be used is transmitted to the selected MFP 10.

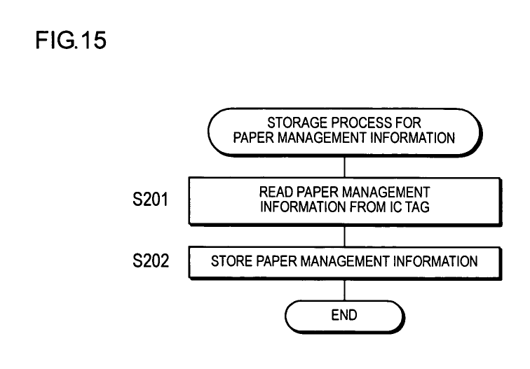

FIG. 15 is a flowchart showing the storage process sequence for the paper management information on the MFP 10. The algorithm shown in the flow chart of FIG. 15 is stored as a program in the storage unit 102 of the MFP 10 and executed by the control unit 101.

First, let us assume that the specified paper management information 50 is written on the entire bundle of the IC-tagged paper 40, which is being loaded on the paper feeding tray.

When the paper is loaded into one of the paper feeding trays of the paper feeding unit 106, the IC tag reader 107 reads the paper management information 50 stored in the IC tag 42 provided on the paper (S201). The paper management information 50 contains the aforementioned department information 51, paper size information 52, and paper type information 53.

The paper management information 50, which is read, is then stored in the storage unit 102 (S202). The number of sheets of the IC-tagged paper 40 loaded in the tray is counted and added as information concerning the remaining amount of paper in the paper management information 50.

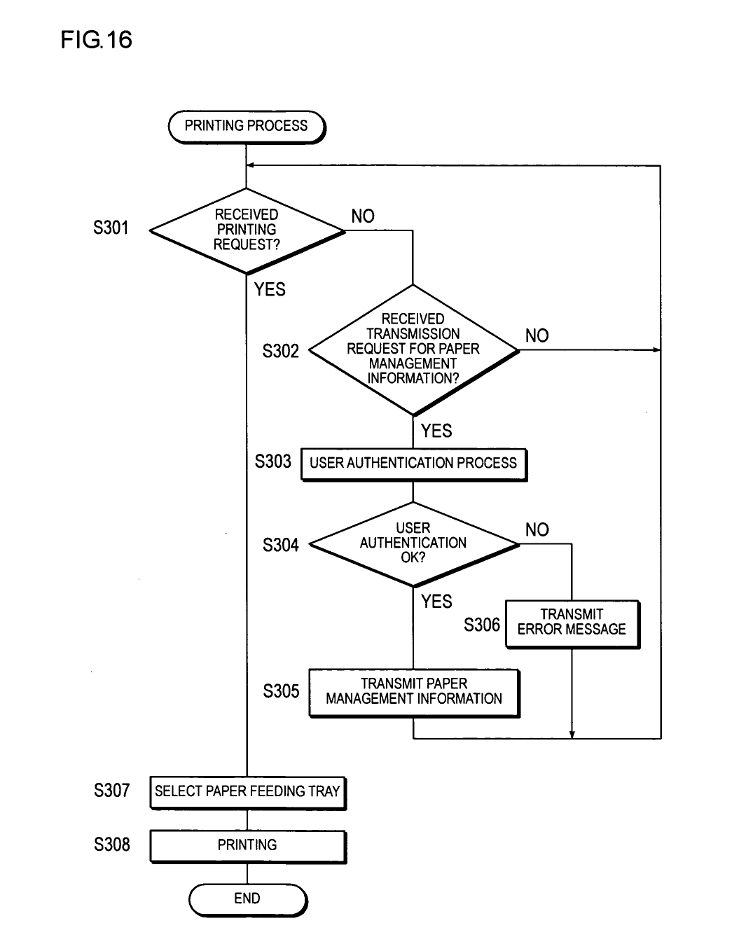

FIG. 16 is a flowchart showing the printing process sequence on the MFP 10. The algorithm shown in the flow chart of FIG. 16 is stored as a program in the storage unit 102 of the MFP 10 and executed by the control unit 101.

The MFP 10 first makes a judgment whether it has received or not a printing request that contains the print data and the printing setup information including the instruction information for the paper feeding tray to be used from, for example, the PC 20 (S301).

If no printing request is received (S301: No), the MFP 10 makes a judgment whether a transmission request for the paper management information 50 is received or not from, for example, the PC 20 (S302). If no transmission request for the paper management information 50 is received (S302: No), the program returns to step S301.

When the transmission request for the paper management information 50 is received (S302: Yes), the user authentication process is performed based on the user's department and the user's name contained in said transmission request (S303). In other words, a judgment is made as to whether the user concerning the transmission request belongs to the department indicated in the transmission request. Such a user authentication process is performed based on the user information preregistered in the MFP 10. However, the user authentication process can be performed also using a directory server (not shown) on the network 30.

If it is proved that the user concerning the transmission request belongs to the department indicated in the transmission request as a result of the user authentication (S304: Yes), the MFP 10 transmits paper management information 50 stored in the storage unit 102 to the PC 20, which is the request source (S305). On the other hand, if the user concerning the transmission request is not proved to belong to the department indicated in the transmission request (S304: No), a specified error message is transmitted to, for example, the PC 20, which is the request source (S306).

If it is judged that a printing request is received in the step S301 (S301: Yes), the MFP 10 selects the paper feeding tray based on the instruction information of the paper feeding tray to be used as included in the printing request (S307).

Next, the MFP 10 picks up a sheet from the selected paper feeding tray and transports it to the image forming unit 109 for printing to be executed (S308). The IC tag writer 108 may write the specified electronic data additionally on the IC tag 42 on the paper at this point.

As can be seen from the above, the present embodiment allows the MFP 10 to read the paper management information 50 including the department information 51 of a department which is authorized to use paper, which is stored in the IC tag 42 provided on the paper, and the paper management information 50 thus obtained to be stored in the storage unit 102. Also, upon receiving the transmission request for the paper management information 50 via the network, the MFP 10 transmits the paper management information 50 stored in the storage unit 102 back to the request source.

Therefore, regardless of which paper feeding tray of the image forming device a recording medium such as paper is set, it is possible to identify in advance the department to which use is authorized for every paper set in the image forming device. Consequently, the paper to be used on the image forming device can be controlled accurately for each department, thus contributing to effective management of resources and global environmental protection.

Next, an image processing system according to the second embodiment of the invention will be described below. The hardware constitution of this embodiment is similar to that of the image processing system according to the first embodiment shown in FIG. 1 through FIG. 4, so that its description is not repeated here. The following description for the second embodiment therefore focuses on those points which are different from the first embodiment.

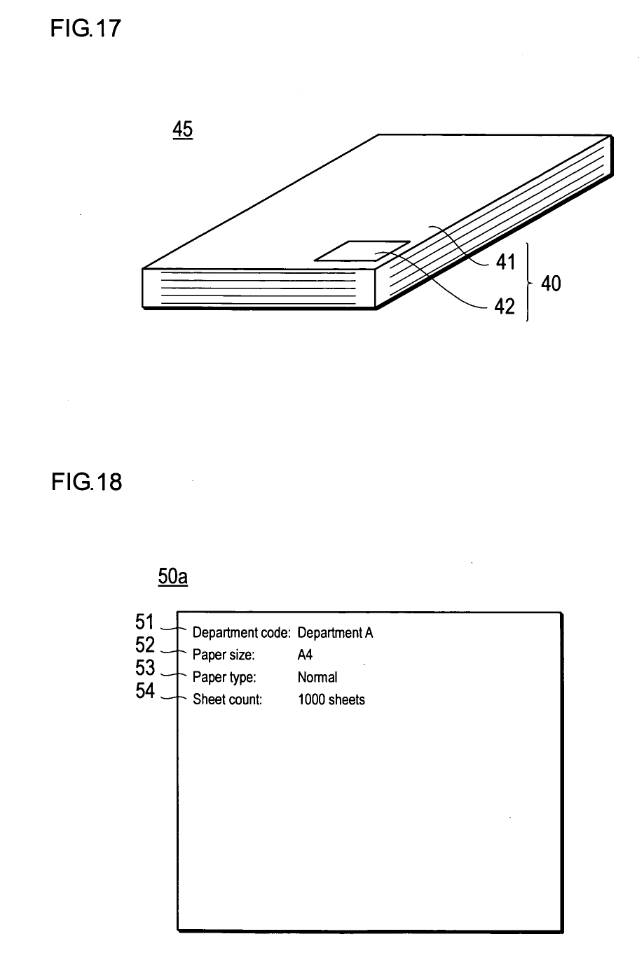

FIG. 17 is a general perspective view of a bundle of paper including IC-tagged paper 40 related to the second embodiment of the invention. The IC tag 42 is provided at least one sheet of paper 41 of the bundle of paper 45 consisting of multiple sheets of paper. For example, in case of the paper bundle 45 shown in FIG. 17, onlythe first sheet is the IC-tagged paper 40. It is possible to maintain the IC-tagged paper 40 to the end of the total usage period of the paper bundle 45 by placing the IC-tagged paper 40 at the bottom of the paper bundle 45. However, the process to be described below can be performed without a problem if the electronic data stored in the IC tag 42 is read and stored in the storage unit 102 before the paper bundle 45 is used for the first time.

FIG. 18 is a diagram for describing the contents of the electronic data stored in the IC tag 42 shown in FIG. 17. The memory part of the IC tag 42 stores paper management information 50a. The paper management information 50a includes sheet count information 54, which indicates the number of sheets that constitute the paper bundle 45, in addition to the aforementioned department information 51, paper size information 52, and paper type information 53.

The printing process sequence in the PC 20 is not repeated here as it is identical to that described in the first embodiment with reference to FIG. 7.

Next, the process sequence for storing the paper management information in the MFP 10 will be described below focusing on those points that are different from the first embodiment described with reference to FIG. 15. As the paper bundle 45 is set in one of the paper feeding trays of the paper feed unit 106, the IC tag reader 107 reads the paper management information 50a stored in the IC tag 42 provided on the IC-tagged paper 40 included in the paper bundle 45 in the step S201. The paper management information 50a contains the sheet count information 54 in addition to the aforementioned department information 51, paper size information 52, and paper type information 53.

Next, the printing process sequence in the MFP 10 will be described below focusing on those points that are different from the first embodiment described with reference to FIG. 16. After the printing is performed by the image forming unit 1-09, the sheet count information 54 for the paper management information 50 is updated by subtracting from the sheet count the number of sheets fed from the selected paper feeding tray in the step S308.

Thus, in the second embodiment, the same effect as the first embodiment can be achieved by having at least one sheet of IC-tagged paper 40 among the paper bundle 45. Therefore, it reduces the paper cost and simplifies the process of using the IC tag 42.

It is obvious that this invention is not limited to the particular embodiments shown and described above but may be variously changed and modified without departing from the technical concept of this invention.

For example, although an MFP is used as the image forming device in the above embodiment, the image forming device of the present invention is not limited to it and other image forming devices such as a printer or a copying machine can be used for the same purpose. Moreover, it can also be constituted in such a way that when the copying function is used on the MFP, the paper management information 50 stored in the storage unit 102 of the MFP 10 is displayed on the operating panel unit 103 so that the user can select a paper try. In such a case, it can also be so constituted that the paper feeding tray, which contains the paper that the user's department can use, is displayed as a selectable option.

Also, although a PC is used as the printing instruction device of the invention in the above mentioned embodiment, the printing instruction device of the present invention is not limited to it and other printing instructions devices such as a portable terminal can be used for the same purpose.

The means and method of conducting various processes in the image processing system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a storage unit such as a hard disk. Said program can also be provided as independent application software or can be built into the software of the image forming device or the printing instruction device as a part of its function.

What is claimed is:

1. An image forming device, comprising:
a reading unit for reading recording medium management information including the information of a department authorized to use a recording medium, which is stored in an IC tag provided on said recording medium; and
a storage unit for storing the recording medium management information read by said reading unit.

2. An image forming device as claimed in claim 1, wherein
said recording medium management information is stored as information related to a recording medium storage part used for storing a recording medium.

3. An image forming device as claimed in claim 1, wherein
said recording medium management information includes sheet count information that is stored in the IC tag and indicates the number of sheets in a recording medium bundle.

4. An image forming device as claimed in claim 1, further comprising:
a receiving unit for receiving a request for said recording medium management information via a network; and
a return transmission unit for returning said recording medium management information stored in said storage unit when said request is received.

5. An image forming device as claimed in claim 4, wherein
said recording medium management information is returned only when a user who is said request's source is authenticated.

6. A printing instruction device, comprising:
a receiving unit for receiving recording medium management information including the information of a department authorized to use a recording medium, which is stored in an IC tag provided on said recording medium loaded in an image forming device, from said image forming device via a network; and
a display unit for displaying the image forming device, which is equipped with a recording medium authorized to be used by the department to which a user issuing a printing instruction belongs, as a selectable image forming device based on said recording medium management information.

7. A printing instruction device as claimed in claim 6, wherein
said recording medium management information is the information related to a recording medium storage part used for storing a recording medium;
said display unit further displays the recording medium storage part, which is equipped with the recording medium authorized to be used by the department to which the user issuing a printing instruction belongs, as a selectable recording medium storage part.

8. A printing instruction device as claimed in claim 6, wherein
said recording medium management information includes sheet count information that is stored in the IC tag and indicates the number of sheets in a recording medium bundle.

9. An image processing system, comprising:
a printing instruction device; and
an image forming device communicable with said printing instruction device via a network,
said image forming device including:
a requesting unit for requesting recording medium management information including the information of a department authorized to use a recording medium, which is stored in an IC tag provided on said recording medium loaded in an image forming device, to said image forming device;
a receiving unit for receiving said recording medium management information from said image forming device via the network; and
a display unit for displaying an image forming device, which is equipped with a recording medium authorized to be used by the department to which a user issuing a printing instruction belongs, as a selectable image forming device based on said recording medium management information,
said image forming device including:
a reading unit for reading said recording medium management information stored in an IC tag provided on the recording medium;
a storage unit for storing the recording medium management information read by said reading unit;
a receiving unit for receiving a request for said recording medium management information via the network; and
a return transmission unit for returning said recording medium management information stored in said storage unit when said request is received.

10. An image forming method comprising the steps of:
1) reading recording medium management information including the information of a department authorized to use a recording medium, which is stored in an IC tag provided on said recording medium; and
2) storing the recording medium management information read in the step 1).

11. An image forming method as claimed in claim 10, wherein
said recording medium management information is stored as information related to a recording medium storage part used for storing a recording medium.

12. An image forming method as claimed in claim 10, wherein
said recording medium management information includes sheet count information that is stored in the IC tag and indicates the number of sheets in a recording medium bundle.

13. An image forming method as claimed in claim 10, further comprising the step of:
3) receiving a request for said recording medium management information via a network; and
4) returning said recording medium management information stored in said storage unit when said request is received.

14. An image forming method as claimed in claim 13, wherein
said recording medium management information is returned only when a user who is said request's source is authenticated in the step 4).

15. A printing instruction method comprising the steps of:
1) receiving recording medium management information including the information of a department authorized to use a recording medium, which is stored in an IC tag provided on said recording medium loaded in an image forming device, from said image forming device via a network; and
2) displaying the image forming device, which is equipped with the recording medium authorized to be used by the department to which a user issuing a printing instruction belongs, as a selectable image forming device based on said recording medium management information.

16. A printing instruction method as claimed in claim 15, wherein
said recording medium management information is the information related to a recording medium storage part used for storing a recording medium; and
in said step 2), the recording medium storage part, which is equipped with the recording medium authorized to be used by the department to which the user issuing a printing instruction belongs, is displayed as a selectable recording medium storage part.

17. A printing instruction method as claimed in claim 15, wherein
said recording medium management information includes sheet count information that is stored in the IC tag and indicates the number of sheets in a recording medium bundle.
